(19) United States
(12) Patent Application Publication
(10) Pub. No.: US 2019/0063985 A1
(43) Pub. Date: Feb. 28, 2019

(54) Method for operating a limit sensor

(71) Applicant: Vega Grieshaber KG, Wolfach (DE)

(72) Inventors: Dominik Fehrenbach, Haslach (DE); Volker Allgaier, Haslach (DE)

(21) Appl. No.: 15/980,451

(22) Filed: May 15, 2018

(30) Foreign Application Priority Data
Aug. 30, 2017 (EP) 17 188 655.9

(51) Int. Cl. G01F 23/296; G01F 23/00; G01F 25/00

(52) U.S. Cl. CPC G01F 23/2967; G01F 25/0061; G01F 23/0007; G01F 23/0069

(57) ABSTRACT

A method for operating a limit sensor, in which the limit sensor is excited for determining a resonance frequency of a vibration system, the vibration system is excited in a frequency range between a lower frequency limit and an upper frequency limit, and a frequency response is subsequently detected, with the frequency range being divided into a plurality of sections, and in case of an unknown resonance frequency the vibration system is excited sequentially respectively in successive sections, and the frequency response after each section is detected, and in case of a known resonance frequency the vibration system is only excited in the section in which the resonance frequency is found, and then the frequency response is detected.

### CROSS REFERENCE TO RELATED APPLICATIONS

This patent application claims priority to European Patent Application 17188655.9, filed on Aug. 30, 2017.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a method of operating a limit sensor.

### Background of the Invention

Limit sensors, particularly vibration limit sensors and impedance limit sensors as well as methods for the operation thereof, are known from prior art.

Typical applications for detecting a predefined fill level (limit) include for example process tanks, storage tanks, silos, or pipelines in the processing industry. Limit sensors are preferably used in various liquids as well as granulated and powdered bulk goods. Various limit sensors are used depending on the characteristics of the fill goods as well as the individual processing conditions. For example, impedance limit sensors, vibration limit sensors, as well as sensors operating according to a capacitive measuring principle are known.

Impedance limit sensors, in which a capacity is formed by the sensor in an oscillating circuit is arranged as the frequency-determining element, are known from the prior art. For example, with a discrete inductivity the sensor capacity can form a serial oscillating circuit. If a measuring medium is present within the range of the capacity, the capacity changes along with the impedance of the oscillating circuit. The impedance can be determined and used for generating a limit measuring signal.

The complex-valued impedance of the oscillating circuit, varied by frequency, is examined with regards to its value for its minimum, i.e. the minimum amplitude, as well as the frequency at which said minimum occurs. In order to generate the limit measurement signal, the frequency shift and an impedance difference are evaluated between an uncovered state as well as a state covered by a medium.

Determining this minimum is achieved by excitation of the oscillating circuit at all potential frequencies via a frequency sweep over the entire frequency range.

Further vibration limit sensors are known from the prior art in which the vibration limit sensor comprises a diaphragm that can be excited by a drive to vibrate, thereby exciting the mechanical vibrator arranged at the diaphragm to vibrate. Depending on a cover status of the mechanical vibrator with fill material, as well as depending on the viscosity of this fill material, the mechanical vibrator oscillates with a characteristic frequency, which can be detected by a vibration sensor and can be converted into a measuring signal.

Such vibration limit sensors for liquids and bulk goods operate based on the principle of resonance frequency shift. The vibration limit sensor oscillates depending on the coverage status, density, and temperature of the medium with various resonance frequencies and amplitudes. The amplitude of the resonance frequency is here dependent on the viscosity of the medium. The frequency shift is dependent on the density, temperature, and viscosity of the medium.

Two different types of oscillating excitation are known from prior art for vibration limit sensors, which are known under the keywords oscillating circuit excitation and system analysis.

During oscillating circuit excitation, the drive of the vibration limit sensor is part of a closed analog or digital oscillating circuit. The vibration limit sensor is thus permanently kept at its mechanical resonance frequency. The oscillation frequency of the oscillating circuit can be evaluated and used for determination of a measurement.

During system analysis, the vibration limit sensor is excited with an arbitrary frequency. This may represent a frequency sweep, a fixed frequency, or a pulse. After excitation, the oscillating system is “listened to” and the frequency of the settling process equivalent to the mechanical resonance frequency is determined. If no signal is received, it is assumed that the vibration limit sensor is in the covered state.

During the excitation of the system with a fixed frequency, said frequency must match the resonance frequency as best as possible so that a sufficiently high amplitude is yielded for determining the frequency of the vibration. When the resonance frequency changes, and/or due to a change between the covered and the uncovered state of the vibration limit sensor it may occur that this form of system analysis is not working, because in this situation only insufficient excitation of the resonance frequency occurs.

In high-quality systems, during the excitation with a square pulse insufficient energy is introduced into the system in order to allow an analysis of the resonance frequency. Due to the fact that, in the sensors used here, limits are typically given for the energy or due to EX-circuits, the height of the square pulse cannot be selected arbitrarily. Accordingly, in such a pulse response insufficient signals are returned.

In order to reliably excite the vibration limit sensor at its resonance frequency during the excitation with a frequency sweep, in prior art a continuous frequency sweep is performed over the entire frequency range. In a frequency sweep with small steps, it can be ensured that the resonance frequency is excited and then a sufficiently “strong” signal is given for detection. As the frequency range in prior art, the entire frequency range of a resonance frequency is used, from the sensor covered with a medium with the maximum viscosity permitted up to a resonance frequency of the system in air. At a frequency of 58% or less in reference to the air frequency of the system, a blocking of the mechanical vibrator is assumed and an error message is issued. An error message is also issued at a frequency of 104% or more in reference to the air frequency of the system. The air frequency of the system represents the frequency at which the mechanical vibrator oscillates under normal conditions in the air.

The higher the coverage of the vibration limit sensor and the viscosity of the medium, the shorter the vibration of the vibration limit switch. In a medium with high viscosity, it can occur that a vibration of the system has already settled when the frequency sweep has concluded.

During the process of the system analysis it can occur that, for example, a jamming or defect at the fork results in a false report of the vibration limit sensor, because the vibration of the mechanics has already subsided when the detection process is initiated. This is the case at high viscosity. However, since it is assumed that this refers to a covered state with high viscosity (also see the description above), in case of a blocked fork (for example by a stone in the process), although no longer covered by medium, it cannot be distinguished any longer between the conditions “blocked” and “covered with medium showing high viscosity”.

The objective of the present invention is to provide a method for operating a limit sensor in which the detection of the resonance frequency occurs faster and with high probability.

This objective is achieved in a method showing the features of claim 1. Advantageous further developments are the objective of the dependent claims.

### BRIEF SUMMARY OF THE INVENTION

In a preferred embodiment, a method for operating a limit sensor, in which the limit sensor for determining a resonance frequency (fᵣₑₛ) of a vibration system excites the vibration system in a frequency range between a lower frequency limit (fₘᵢₙ) and an upper frequency limit (fₘₐₓ) and a frequency response (E) is subsequently detected characterized in that the frequency range is divided into a plurality of sections (I, II, III, IV, . . . , n) and a) in case of unknown resonance frequency (fᵣₑₛ) the vibration system sequentially excites respectively successive sections (I, II, III, IV, . . . , n) and detects the frequency response (E_{I}, E_{II}, E_{III}, E_{IV}, . . . , En) after each section (I, II, III, IV, . . . , N), b) in case of a known resonance frequency (fᵣₑₛ) the vibration system excites only in the section (N), in which the resonance frequency (fᵣₑₛ) is given, and then the frequency response (Eₙ) is detected.

In a preferred embodiment, a method as described herein, characterized in that the frequency range is divided into four sections (I, II, III, IV).

In a preferred embodiment, a method as described herein, characterized in that the frequency range in case a) is divided into four sections (I, II, III, IV) and in case b) the section, in which the resonance frequency (Fᵣₑₛ is given, is dynamically adjusted.

In a preferred embodiment, a method as described herein, characterized in that in case b) for vibration limit sensors the section is determined from 50 Hz below the most recently detected resonance frequency (fᵣₑₛ₋₁) to 50 Hz above the most recently detected resonance frequency (fᵣₑₛ₋₁) and for the impedance limit sensors the section is determined from 10 MHz below the most recently detected resonance frequency (fᵣₑₛ₋₁) to 10 MHz above the most recently detected resonance frequency (fᵣₑₛ₋₁).

In a preferred embodiment, a method as described herein, characterized in that in case b) if the resonance frequency (fᵣₑₛ) is not detected within the previous section in which the most recently detected resonance frequency (fᵣₑₛ₋₁) was located, initially a first section directly adjacent to the previous section is excited and the frequency is detected and then, if the resonance frequency (fᵣₑₛ) is not found there, a second section abutting the previous section is excited and the frequency response is detected.

In a preferred embodiment, a method as described herein, characterized in that in case the resonance frequency (fᵣₑₛ) is not found in any of the adjacent sections, procedure occurs like in case a).

In a preferred embodiment, a method as described herein, characterized in that the individual sections are each excited with a frequency sweep from an upper end of the section to a lower end of the section.

In a preferred embodiment, a method as described herein, characterized in that in case a) the sections are processed in falling sequence.

In a preferred embodiment, a method as described herein, characterized in that in case b), when the resonance frequency (fᵣₑₛ) is not detected in the previous section, in which the most recently detected resonance frequency (fᵣₑₛ₋₁) was found, the upper limit and the lower limit of the section for vibration limit sensors are expanded by 50 Hz respectively, and for impedance limit sensors by respectively 10 MHz towards the top and/or the bottom, and in case the resonance frequency is not found in the enlarged section, processing occurs according to case a).

### BRIEF DESCRIPTION OF THE DRAWINGS

FIG. 1A a typical frequency range in which the resonance frequency of a vibration limit sensor according to the present application may be located.

FIG. 1B frequency responses which may be obtained during the excitation according to FIG. 1A.

FIG. 2 a flow chart of a first variant of the method of the present application.

FIG. 3a a variant of the method according to the present application.

FIG. 3b frequency responses in case of an excitation according to FIG. 2a.

FIG. 4 a variant of the method according to FIG. 2.

FIG. 5 the amount of the complex-value impedance of an impedance limit sensor as a function of the measuring frequency.

FIG. 6a the excitation of a vibration limit sensor according to prior art.

FIG. 6b the frequency response with a frequency excitation according to FIG. 6a.

### DETAILED DESCRIPTION OF THE INVENTION

A method according to the invention for operating a limit sensor, in which the limit sensor is used for the determination of a resonance frequency of a vibration system, in which the vibration system is excited in a frequency range between a lower frequency limit and an upper frequency limit and then a frequency response is detected, is characterized in that the frequency range is divided into a plurality of sections and
a) in case of an unknown resonance frequency the vibration system is excited sequentially in respectively successive sections, and depending on the respective section the frequency response is detected, b) in case of a known resonance frequency the vibration system is excited only in the section in which the resonance frequency is given, and then the frequency response is detected.

A method according to the invention for operating a limit sensor is advantageous in the case of a vibration limit sensor in that, by the division of the frequency range into several sections in case of an unknown resonance frequency, even in case of complete coverage of the vibration limit sensor with a medium of high viscosity, reliable detection of the resonance frequency is possible when it is located within said section. This results from the fact that in each section more energy of the correct frequency is introduced and thus the mechanical vibration of the vibration fork can excite with a higher amplitude. Thus a higher amplitude is also returned. The sections are here ideally selected such that a frequency response of the vibration system is possible even at maximum coverage of the vibration limit sensor with a medium of the highest permitted viscosity, i.e. at maximum damping of the vibration signal. Another advantage of the above described method is given in that, in case of a known resonance frequency, the vibration system only needs to be excited in the section in which the resonance frequency is given, so that a considerably faster determination of the resonance frequency is possible. Further, by the method according to the invention, in the correct frequency range, i.e. in the section in which the frequency range is given, more energy can be introduced so that the resonance frequency is excited with a higher amplitude, and a signal with a higher amplitude can thus also be received.

Both in vibration limit sensors as well as impedance limit sensors, the resonance frequency can be found faster with the method according to the invention than in prior art.

In order to ensure reliable detection of the frequency response, a minimum amplitude received showing approx. 10% of the maximum amplitude received is required for vibration limit sensors. Alternatively, a minimum signal to noise ratio (SNR), i.e. the ratio of usable signal to mere noise, can be determined, with the minimum SNR showing at least 3 dB, preferably at least 5 dB, even more preferably greater than 10 dB. The sections for exciting the vibration systems are therefore ideally selected such that at maximum damping, even at the end of a frequency sweep over the section sufficient amplitude is still available for the starting frequency of the frequency sweep in the section, i.e. the minimum frequency received is yielded or a SNR of 3 dB is not fallen short of

Texts have shown that, in a common vibration limit sensor, a division of the frequency range into four sections yields good results. If potential frequency responses are for example given at a frequency range between 800 Hz and 1400 Hz, the frequency range can be divided into four equally sized sections of 150 Hz each.

In an alternative embodiment of the method, the frequency range at an unknown resonance frequency can be divided into four sections, and in case of a known resonance frequency the section in which the resonance frequency is given can be dynamically adjusted. This way, in case of a shift of the resonance frequency, the section in which the resonance frequency is given can follow it and a determination of the resonance frequency can reliably be achieved in a considerably shorter time. The section in which the resonance frequency is given can be determined, for example based on the most recently detected resonance frequency, from 50 Hz below the last detected resonance frequency to 50 Hz above the last detected resonance frequency. Alternatively, the section can also end 75 Hz or 100 Hz below and/or above the most recently detected resonance frequency.

By an appropriate determination of the limit frequencies of the section, on the one hand, a quick determination of the resonance frequency can be ensured within the section, and on the other hand, it can also be ensured that in case of a shift of the resonance frequency the resonance frequency is still excited in the section in which the vibration system is given and is thus detected.

In the event that the resonance frequency is not detected in the previous section, in which the last resonance frequency was detected, initially a first section directly adjacent the previous section can be excited with a frequency sweep and the frequency response can be detected. If the resonance frequency is not found there, a second section adjacent to the previous section can be excited and the frequency response detected. Advantageously for this purpose the section is selected first which is closer to the shift threshold so that any change of the shift condition can be detected as quickly as possible. This way, even in case of a more distinct shift of the resonance frequency, the measuring signal can be quickly repositioned.

In the event that the resonance frequency is not detected in any adjacent section either, the method can be processed as provided for unknown resonance frequencies.

Ideally the individual sections can each be excited with a frequency sweep from an upper end of the section to a lower end of the section. A frequency is understood in the present invention to be a sequential excitation of a plurality of frequencies within a frequency range at predetermined increments. The predetermined increments may range from 1 Hz to 4 Hz, particularly 1 Hz, 2 Hz, 3 Hz, or 4 Hz. Frequency sweeps can generally be performed with rising or falling values, according to the present invention with falling frequency sweeps, i.e. showing a sequential excitation of the vibration system with incrementally falling frequencies, being preferred, showing for example 4 Hz-increments.

In this way due to the fact that a damping of the excited vibrations increases with falling frequencies, it can be ensured that, even for lower frequencies within a section, sufficient vibration amplitude remains for system analysis.

Additionally, in the event of unknown resonance frequencies, the individual sections can be processed in a falling sequence, i.e. from the higher to the lower frequencies.

In the event that the resonance frequency is known from a previous measurement and the resonance frequency is not detected in the previous section, in which the most recently detected resonance frequency was found, the upper limit and the lower limit of the section can be shifted upwards and/or downwards, for example by 50 Hz each, i.e. the section is enlarged. In the event that the resonance frequency is not found in the enlarged section either, the method for unknown resonance frequencies can be applied. In case of an enlargement of the section, any other suitable frequency value can also be used.

In the following, the present invention is explained in greater detail with reference to the attached figures. Unless stipulated otherwise, identical reference characters mark identical or equivalent components.

### DETAILED DESCRIPTION OF THE FIGURES

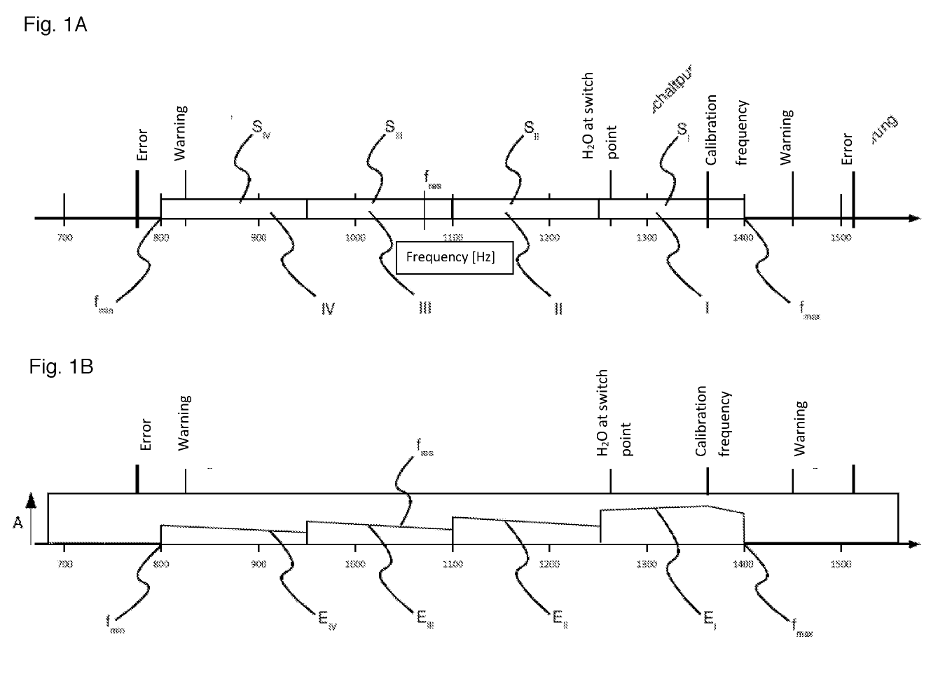

FIG. 1 shows a typical frequency range in which vibration limit sensors are operated as known from prior art.

Typical frequencies range, as shown in FIG. 1A, from a lower frequency limit of fₘᵢₙ of 800 Hz and an upper frequency limit fₘₐₓ of 1400 Hz, with a resonance frequency fᵣₑₛ of a mechanical vibrator of the vibration limit sensor being dependent on a coverage state of the mechanical vibrator with the fill good as well as the viscosity of said fill good. The determination of the resonance frequency fᵣₑₛ occurs in the present exemplary embodiment according to the principle of the so-called system analysis, in which, according to the present application, the vibration system of the vibration limit sensor being divided into four sections I, II, III, and IV, in which the frequency range being examined between the lower frequency limit fₘᵢₙ and the upper frequency limit fₘₐₓ with so-called frequency sweeps, i.e. the sequential excitation with a plurality of successive frequencies within a section.

In the present exemplary embodiment, in case of an unknown resonance frequency fᵣₑₛ of the vibration system, four frequency sweeps S_{I}, S_{II}, S_{III}, S_{IV} are successively performed, with after each frequency sweep S_{I}, S_{II}, S_{III}, S_{IV} one frequency response E_{I}, E_{II}, E_{III}, E_{IV} of the vibration system being detected.

In the event that the resonance frequency fᵣₑₛ is given in the range of a frequency sweep S_{I}, S_{II}, S_{III}, S_{IV}, after the conclusion of the frequency sweep S_{I}, S_{II}, S_{III}, S_{IV} a frequency response E_{I}, E_{II}, E_{III}, E_{IV} of the vibration system is detected responding to this resonance frequency fᵣₑₛ, so that the resonance frequency fᵣₑₛ can be determined.

In the present exemplary embodiment, the frequency sweeps S_{I}, S_{II}, S_{III}, S_{IV} are respectively performed from the highest to the lowest frequency within a section I, II, III, IV, with the four sections I, II, III, IV showing identical sizes of respectively 150 Hz. The sections are also processed in falling sequence.

The illustration of FIG. 1A also shows other additional characteristic frequencies for the sections I, II, III, IV. Shown here is for example the so-called calibration frequency of 1375 Hz, which is equivalent to a vibration frequency of the mechanical vibration system in air. Further, a frequency of 1260 Hz is shown, which represents the resonance frequency of the mechanical vibration system at the switch point, i.e. at a change of the coverage of the vibration limit sensor from air to water. Above the calibration frequency, at a frequency of 1450 Hz, a warning is issued, and upon reaching a frequency of 1520 Hz a malfunction is assumed. At the lower end of the frequency range a warning is issued upon reaching a frequency of 820 Hz, and a malfunction when a frequency of 780 Hz is not reached. Due to the fact that the above-mentioned frequencies, based on production tolerances, may fluctuate, they are frequently also stated as a function to the calibration frequency.

FIG. 1B shows the maximum amplitude possible for a frequency response for the respective resonance frequencies at an excitation with falling frequency sweeps S_{I}, S_{II}, S_{III}, S_{IV} according to FIG. 1A. From the illustration shown in FIG. 1B, it is discernible that at an excitation according to FIG. 1A for all potential resonance frequencies fᵣₑₛ in the frequency range from the lower frequency limit fₘᵢₙ and the upper frequency limit fₘₐₓ a sufficient amplitude A is available for the system analysis and thus for the determination of the resonance frequency fᵣₑₛ. The individual signals received, E₁, E₂, E₃, E₄ are each of sufficient size that even under poor measuring conditions sufficiently reliable detection is possible of the resonance frequency fᵣₑₛ.

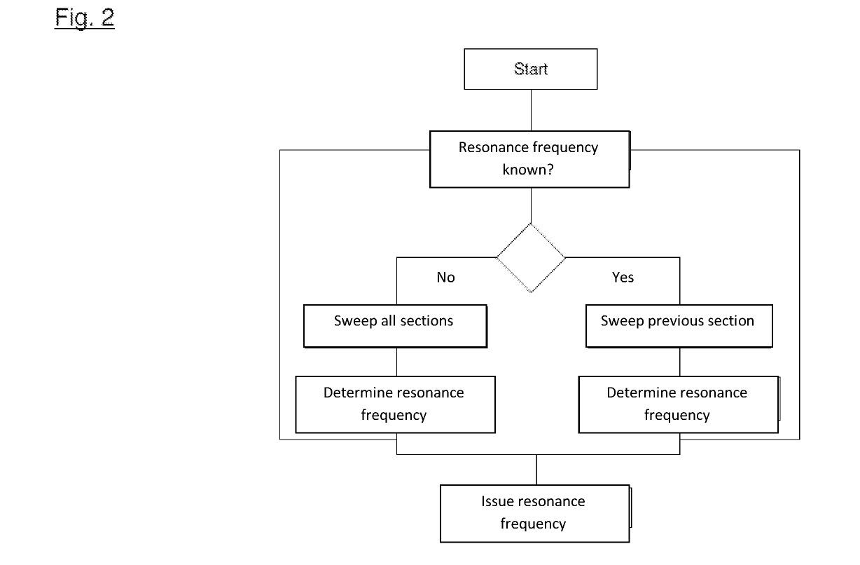

The method for operating the vibration limit switch is shown in FIG. 2. If a resonance frequency fᵣₑₛ is not known, here all sections I, II, III, IV are excited with a frequency sweep S_{I}, S_{II}, S_{III}, S_{IV} and after each frequency sweep S_{I}, S_{II}, S_{III}, S_{IV} a vibration frequency of the vibration system of the vibration limit sensor is determined. This way, when the frequency range is divided between the lower frequency limit fₘᵢₙ and the upper frequency limit fₘₐₓ into four sections I, II, III, IV, a reliable determination of the resonance frequency fᵣₑₛ can occur. If the resonance frequency fᵣₑₛ of the vibration system is known from a first measurement performed, in a subsequent measurement a frequency sweep of only one section can occur, in which the previously determined resonance frequency fᵣₑₛ₋₁ was found. As long as the resonance frequency fᵣₑₛ is given in this section, a frequency sweep S_{I}, S_{II}, S_{III}, S_{IV} must be performed only in said section I, II, III, IV. The required measuring time is therefore considerably shortened. If the resonance frequency fᵣₑₛ cannot be detected in the respective section I, II, III, IV in which the previously detected resonance frequency fᵣₑₛ₋₁ was found, a frequency sweep can either occur directly over all sections as described above, or alternatively at first in the sections directly adjacent to the previous section, and only if no determination of the resonance frequency fᵣₑₛ is possible in these sections, a sweep can be performed over all sections I, II, III, IV.

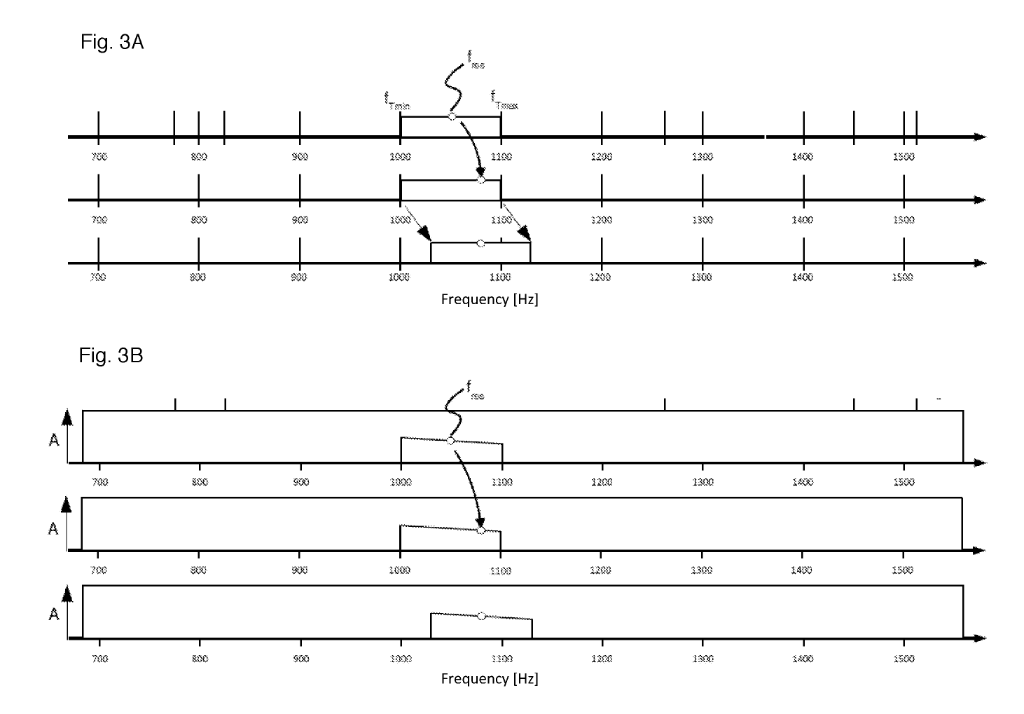

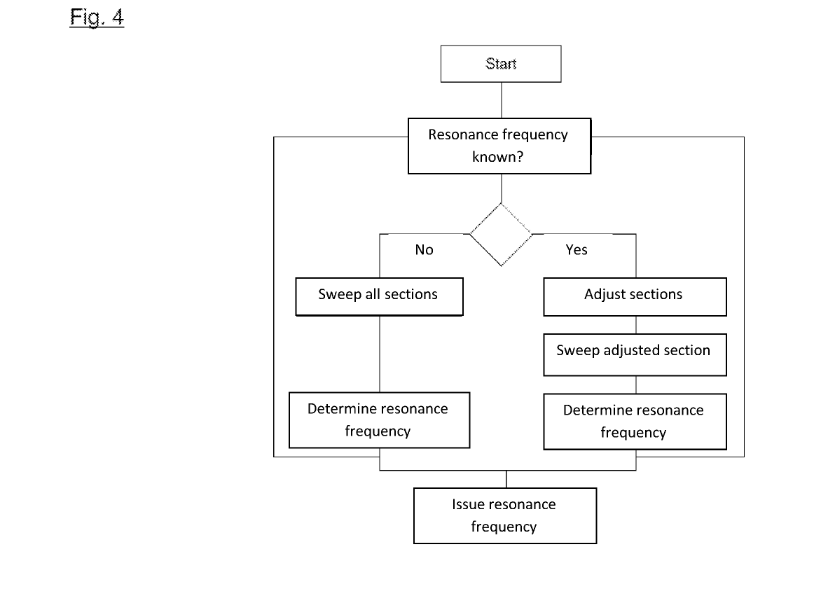

FIGS. 3a and 3b as well as FIG. 4 describe an alternative method for operating a vibration limit sensor.

FIG. 3a shows once more the frequency range displayed in FIG. 1A between the lower frequency limit fₘᵢₙ of 800 Hz and the upper frequency limit fₘₐₓ of 1400 Hz, with the three lines of FIG. 3a showing the procedure during a shift of the resonance frequency fᵣₑₛ from 1050 Hz in the first line to a value of 1075 Hz in the second line. With this alternative method, in the case of a shift of the resonance frequency fᵣₑₛ, the section in which a frequency sweep is performed is adjusted dynamically to the respectively earlier detected resonance frequency fᵣₑₛ₋₁. If this resonance frequency, as shown in FIG. 3a, shifts from 1050 Hz to 1075 Hz, the lower frequency limit f_{Tmin} of the section and the upper frequency limit f_{Tmax} of the section f_{Tmin}=1000 Hz and f_{Tmax}=1100 Hz are adjusted to f_{Tmin}=1025 Hz and f_{Tmax}=1125 Hz so that the detected resonance frequency fᵣₑₛ is once more centrally in the section which is excited with a frequency sweep. This way a dynamic adjustment of the limits of the section in which the resonance frequency fᵣₑₛ is given can occur, so that frequency sweeps can be avoided over several sections, because the resonance frequency fᵣₑₛ was lost, i.e. is no longer known. FIG. 3b shows the respective frequency response for the resonance frequencies possible in the excited section. By the respective procedure loss of the resonance frequency can be avoided, so that in most cases only one frequency range needs to be swept, in the present case 100 Hz.

A respective process is shown in FIG. 4. According to the procedure shown, in case of an unknown resonance frequency fᵣₑₛ, a sweep is performed over all sections as shown in FIG. 1A, and the current resonance frequency fᵣₑₛ is determined. As soon as the resonance frequency is known, a dynamic adjustment of the section is performed and a frequency sweep is performed only in the adjusted section. If in the present procedure, as a result of an excessively fast change of the resonance frequency fᵣₑₛ it is lost, i.e. the resonance frequency fᵣₑₛ is no longer given in the swept section, this section can be either dynamically enlarged, i.e. the lower frequency limit of the section fₚₘᵢₙ can be shifted downwards and the upper limit of the section fₚₘₐₓ can be shifted upwards, for example by 100 Hz, or an immediate sweep can be performed over all sections according to the method described with regards to FIGS. 1 and 2.

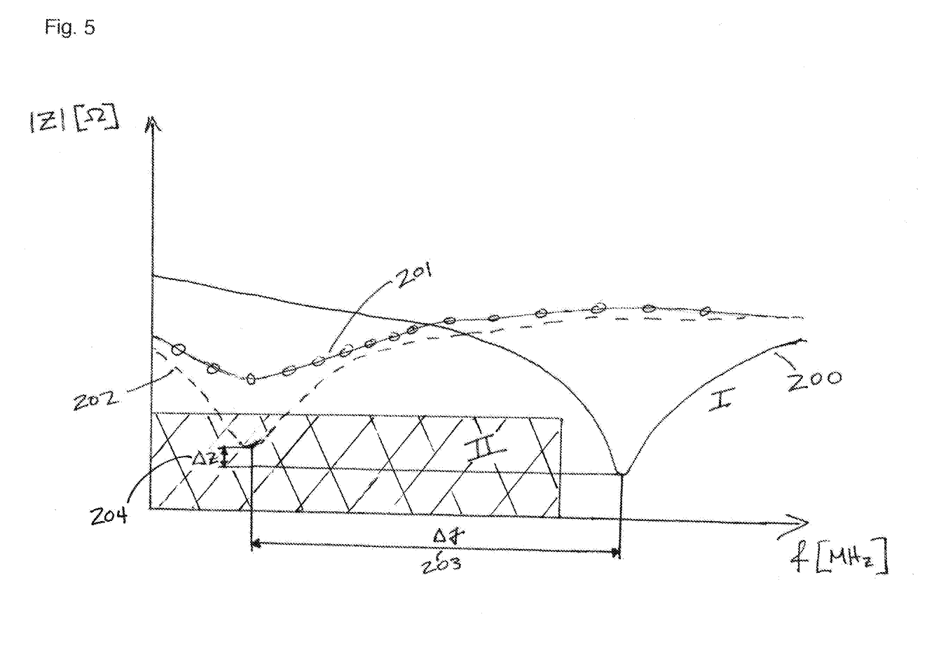

FIG. 5 shows the amount of the complex-valued impedance (|Z|) over the measuring frequency (f). The impedance measurement ideally occurs in a frequency range between 100 MHz and 200 MHz, with the minimum of the determined resonance curve being decisive in each case.

FIG. 5 shows the impedance behavior of a clean, uncovered impedance limit sensor in characteristic 200, a sensor soiled with a measuring medium in characteristic 201, and a completely covered sensor in characteristic 202. Only the minimums of the resonance curves are considered for the analysis. They are evaluated with regards to the frequency change Δf and the amplitude change Δ |Z|. If the minimum of the resonance curve is located in the section I, the evaluation and control unit issues the shift command empty. If, however, the minimum is in the section II, the full status is detected and issued.

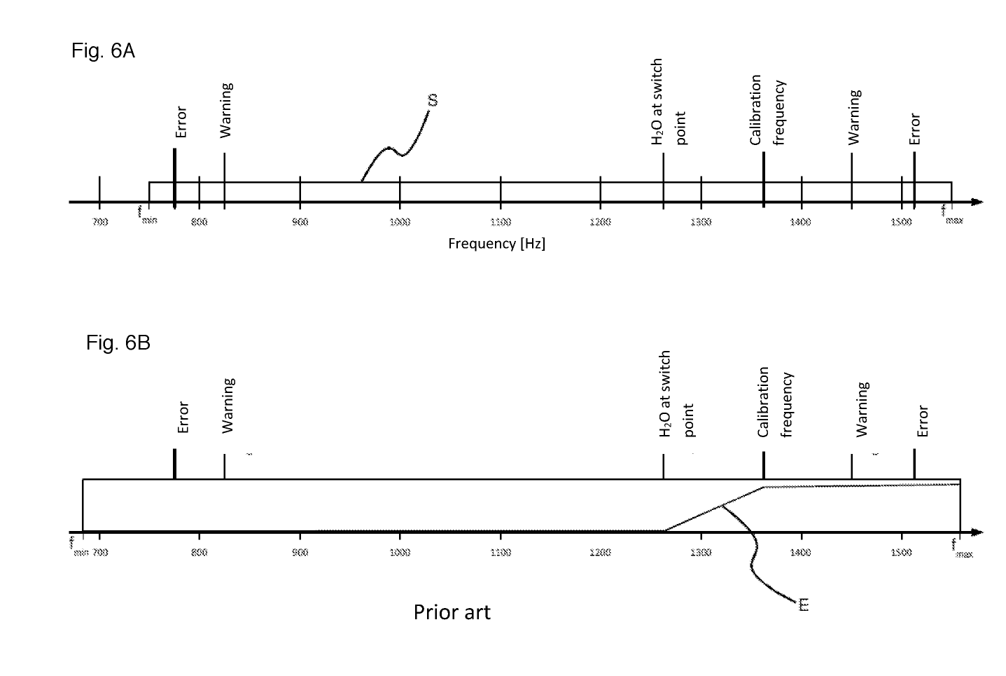

FIG. 6 shows a frequency range between a lower frequency limit fₘᵢₙ and an upper frequency limit fₘₐₓ, as used in prior art for vibration limit sensors. According to a method for operating vibration limit sensors common in prior art, for determining the resonance frequency fᵣₑₛ a frequency sweep S is performed over the entire frequency range from the lower frequency limit fₘᵢₙ to the upper frequency limit fₘₐₓ. As shown in FIG. 6b, under these circumstances, particularly in case of fill media with a higher viscosity than water, the situation occurs that an amplitude of the received signal E, as shown in FIG. 1B, cannot be detected any longer. For example, a resonance frequency at 1080 Hz as shown in FIG. 1, cannot be detected. If that is the case, a differentiation between a malfunction, for example due to blocking of the vibration limit sensor or a switch signal due to a coverage of the vibration limit sensor with a highly viscous medium, cannot be made reliably any longer, so that respective sensors cannot be used in case of highly viscous media.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A method for operating a limit sensor, in which the limit sensor for determining a resonance frequency of a vibration system excites the vibration system in a frequency range between a lower frequency limit and an upper frequency limit and a frequency response is subsequently detected characterized in that the frequency range is divided into a plurality of sections and a) in case of unknown resonance frequency the vibration system sequentially excites respectively successive sections and detects the frequency response after each section, b) in case of a known resonance frequency the vibration system excites only in the section, in which the resonance frequency is given, and then the frequency response is detected.

2. The method according to claim 1, wherein the frequency range is divided into four sections.

3. The method according to claim 1, wherein the frequency range in case a) is divided into four sections and in case b) the section, in which the resonance frequency is given, is dynamically adjusted.

4. The method according to claim 3, wherein in case b) for vibration limit sensors the section is determined from 50 Hz below the most recently detected resonance frequency to 50 Hz above the most recently detected resonance frequency and for the impedance limit sensors the section is determined from 10 MHz below the most recently detected resonance frequency to 10 MHz above the most recently detected resonance frequency.

5. The method according to claim 1, wherein in case b) if the resonance frequency is not detected within the previous section in which the most recently detected resonance frequency was located, initially a first section directly adjacent to the previous section is excited and the frequency is detected and then, if the resonance frequency is not found there, a second section abutting the previous section is excited and the frequency response is detected.

6. The method according to claim 5, wherein in case the resonance frequency is not found in any of the adjacent sections, procedure occurs like in case a).

7. The method according to claim 1, wherein the individual sections are each excited with a frequency sweep from an upper end of the section to a lower end of the section.

8. The method according to claim 1, wherein in case a) the sections are processed in falling sequence.

9. The method according to claim 4, wherein in case b), when the resonance frequency is not detected in the previous section, in which the most recently detected resonance frequency was found, the upper limit and the lower limit of the section for vibration limit sensors are expanded by 50 Hz respectively, and for impedance limit sensors by respectively 10 MHz towards the top and/or the bottom, and in case the resonance frequency is not found in the enlarged section, processing occurs according to case a).
